(19) United States
(12) Patent Application Publication
(10) Pub. No.: US 2024/0045376 A1
(43) Pub. Date: Feb. 8, 2024

(54) METHOD AND DEVICE FOR TRANSMITTING DATA REPRESENTING A DIGITAL HOLOGRAM, METHOD AND DEVICE FOR CONSTRUCTING A DIGITAL HOLOGRAM AND SYSTEM FOR TRANSMITTING AND CONSTRUCTING A DIGITAL HOLOGRAM

(71) Applicant: FONDATION B-COM, CESSON-SEVIGNE (FR)

(72) Inventor: Anas EL RHAMMAD, Saint-Armel (FR)

(21) Appl. No.: 18/259,059

(22) PCT Filed: Dec. 22, 2021
(86) PCT No.: PCT/EP2021/087270

§ 371 Date: Jun. 22, 2023

(30) Foreign Application Priority Data
Dec. 23, 2020 (FR) FR2014050

(51) Int. Cl. G03H 1/08

(52) U.S. Cl. CPC G03H 1/0808

(57) ABSTRACT

A method for transmitting data representing a digital hologram includes: —determining raw values of a group of parameters, the raw values being determined so that a first scalar product between the hologram and a first decomposition wavelet characterized by the raw values is the maximum; —computing, for each parameter of the group, a refinement value as a function of a derivation scalar product determined on the basis of a scalar product between the hologram and a derivative of the first wavelet relative to the parameter; —determining a coefficient on the basis of a second scalar product between the hologram and a second decomposition wavelet characterized by the refinement values; and —transmitting: i) data representing the refinement values; and ii) of the coefficient.

### TECHNICAL FIELD OF THE INVENTION

The present invention relates to the technical field of digital holography.

More particularly, it relates to a method and a device for transmitting data representing a hologram. It also relates to a method and a device for constructing a digital hologram. Finally, it relates to a system for transmitting and constructing a digital hologram.

### STATE OF THE ART

It has been proposed to decompose a digital hologram on the basis of a dictionary of decomposition functions comprising a predetermined number of these latter. Each decomposition function is characterized by spatial frequency parameters whose values are selected in a set of discrete values. When the digital hologram has to be reconstructed by means of a remote holographic display, a representation of the hologram based on at least certain of these decomposition functions is transmitted.

Conventionally, to faithfully reconstruct a digital hologram, the digital hologram is decomposed into a dictionary comprising a high number of decomposition functions. The denser the dictionary, i.e. the higher the number of functions, the finer the decomposition. This translates into the fact that the spatial frequency parameters are selected from a great number of discrete values. When the dictionary is dense enough, a redundant decomposition can thus be obtained, allowing not to lose information at the time of transmission.

It is also known, in order to obtain a parsimonious decomposition, to use an iterative method of decomposition of the “matching pursuit” type. First, the decomposition function that best represents the hologram is determined. Then, a residue of the hologram is calculated by subtracting from the hologram the part thereof that is represented by the first function. A second decomposition function that best represents the residue is determined, and so on.

However, even with a parsimonious decomposition, a dense dictionary results in an expensive decomposition in terms of computing time because the decomposition requires testing a significant number of discrete values at each iteration. The decomposition is also expensive in terms of storage space because it is necessary to record all the discrete values that can be taken by the parameters. Finally, the quantity of information to be transmitted can be significant when the hologram is decomposed into a significant number of functions.

### DISCLOSURE OF THE INVENTION

In this context, it is proposed according to the invention a method for transmitting data representing a digital hologram comprising the following steps:
determining raw values of a group of parameters, each raw value being determined from a discrete set of predetermined values, said raw values being determined in such a way that a first scalar product between said hologram and a first decomposition wavelet characterized by said raw values is maximum;
for each parameter of said group, computing a refinement value as a function of a scalar product of derivation determined on the basis of a scalar product between said hologram and a derivative of said first wavelet relative to said parameter;
determining a coefficient on the basis of a second scalar product between said hologram and a second decomposition wavelet characterized by fine values obtained by a combination of said raw values and said refinement values;
transmitting:
i) data representing said refinement values;
ii) said coefficient (c_{K}). Thus, thanks to the invention, a digital hologram can be decomposed on the basis of a dictionary comprising a limited number of functions that are here decomposition wavelets. Indeed, at the time of decomposition, the discrete values determined during the successive iterations are adjusted. Therefore, it is not necessary to start from a great number of discrete values to find the most appropriate values, as in the state of the art.

In other words, computing refinement values for the parameters characterizing the decomposition functions makes it possible to limit the discrete set of predetermined values.

When implementing an iterative method, for example with a matching pursuit method, the number of discrete values to be tested at each iteration is thus significantly reduced, therefore limiting the required computation time and storage space.

Moreover, the digital hologram can be finely decomposed because the refinement values enable an optimization of the decomposition function that is determined at each iteration.

The quantity of information to be transmitted to reconstruct the digital hologram is also reduced. On the one hand, due to the fact that, once optimized, the decomposition functions represent accurately the hologram, a limited number of decomposition functions is sufficient. On the other hand, as will be described hereinafter, due to the fact that the transmission of only part of the data stemming from the decomposition allows reconstructing the hologram. The quantity of information transmitted is then even more reduced.

Moreover, the high quality of the spatial frequency decomposition according to the invention makes it possible to improve many functionalities linked to the digital holograms as, for example, holographic signal analysis, hologram edition, movement estimation or dynamic hologram generation.

This transmission method can also be used in the case of a holographic streaming depending on the position of an observer: indeed, the refinement step provides greater precision on the light emission directions, thus a better quality of the view reconstructed from a sub-hologram corresponding to the observation window corresponding to the observer's position.

Other non-limiting and advantageous features of the transmission method according to the invention, taken individually or according to all the technically possible combinations, are the following:
the transmission step comprises transmitting iii) data representing said raw values;
said group includes at least one frequency parameter, said method comprising a step of transmitting, for each frequency parameter, metadata representing said discrete set of values;
said group includes at least one frequency parameter, and said data representing said refinement values include, for each frequency parameter, a real part of said scalar product of derivation;
said group includes at least one spatial parameter, said method comprises a step of transmitting data representing the raw value of each spatial parameter;
said method comprises a step of quantifying said refinement values, and a step of obtaining said fine values of the basis of said quantified refinement values;
said method comprises a step of transmitting a decision relating to a comparison between the modulus of said first scalar product and the modulus of said second scalar product;
said method comprises a step of encoding said data representing said refinement values and said coefficient into a data flow;
said method comprises a step of determining other raw values, characterizing another decomposition wavelet, of the group of parameters, and said data representing the raw value of each spatial parameter include, for each spatial parameter, the raw value or the other raw value and a difference between the raw value and the other raw value.

The present invention also relates to a device for transmitting a digital hologram comprising:
a decomposition module programmed to carry out the following steps:
a) determining raw values of a group of parameters, each raw value being determined from a discrete set of predetermined values, said raw values being determined in such a way that a first scalar product between said hologram and a first decomposition wavelet characterized by said raw values is maximum;
b) for each parameter of said group, computing a refinement value as a function of a scalar product of derivation determined on the basis of a scalar product between said hologram and a derivative of said first wavelet relative to said parameter; c) determining a coefficient on the basis of a second scalar product between said hologram and a second decomposition wavelet characterized by fine values obtained by a combination of said raw values and said refinement values;
a transmission module designed to transmit:
i) data representing said refinement values;
ii) said coefficient.

The present invention also relates to a method for constructing a digital hologram comprising the following steps:
receiving:
i) data representing refinement values of a group of parameters, and
ii) a coefficient associated with a decomposition wavelet;
determining construction values on the basis of said data representing said refinement values, each construction value being associated with a parameter of said group;
determining said decomposition wavelet characterized by said construction values;
constructing said hologram by weighting said decomposition wavelet by said coefficient.

This particularly advantageous method makes it possible to construct a digital hologram from a reduced number of data representing this hologram. Indeed, it is not necessary to receive all the data stemming from the decomposition to construct the hologram.

Other non-limiting and advantageous features of the construction method according to the invention, taken individually or according to all the technically possible combinations, are the following:
said method comprises, for at least one parameter from the group of parameters, a step of determining, on the basis of said data representing said refinement values, a raw value relating to this parameter from discrete set of values;
said method comprises, at least for said parameter, a step of determining said construction value on the basis of said data representing said refinement values and said raw value relating to said parameter, said parameter being in particular a frequency parameter;
said method comprises a step of receiving a decision and said decomposition wavelet is also determined on the basis of said decision;
said method comprises a step of decoding said data flow and extracting said data representing refinement values and said coefficient;
said method comprises a step of receiving metadata and a step of determining said discrete set of values on the basis of the metadata;
the reception step comprises receiving iii) data representing at least one raw value relating to at least one parameter from the group of parameters.

The present invention also relates to a device for constructing a digital hologram comprising:
a reception module designed to receive:
i) data representing refinement values of a group of parameters,
ii) a coefficient associated with a decomposition wavelet;
a decoding module programmed to carry out the following steps:
a) determining construction values on the basis of said data representing said refinement values, each construction value being associated with a parameter of said group;
b) determining said decomposition wavelet characterized by said construction value;
a construction module programmed to carry out the following steps:
c) constructing said hologram by weighting said decomposition wavelet by said coefficient.

The present invention also relates to a system for transmitting and constructing a digital hologram comprising a transmission device as described hereinabove and a construction device as described hereinabove.

Other non-limiting and advantageous features of the transmission and construction system according to the invention, taken individually or according to all the technically possible combinations, are the following:
the transmission device comprises an encoding module programmed to encode said data representing said refinement values and said coefficient into a data flow;
said reception module receives the data flow comprising said data representing said refinement values and said coefficient, and said decoding module is programmed to decode said data flow and extract said data representative of refinement values and said coefficient.

The present invention finally relates to a data flow including:
a first set of data representing fine values obtained by a combination of raw values, characterizing a first decomposition wavelet, and refinement values computed as a function of scalar products of derivation determined on the basis of scalar products between a digital hologram and a derivative of said first decomposition wavelet;
a second set of data representing a coefficient determined on the basis of a scalar product between said hologram and a second decomposition wavelet characterized by said fine values.

Other non-limiting and advantageous features of the data flow according to the invention, taken individually or according to all the technically possible combinations, are the following:
said data flow includes a third set of data representing said raw values, said raw values being determined in such a way that a scalar product between the hologram and said first decomposition wavelet is maximum;
said data flow includes a fourth set of data representing discrete sets of predetermined values, each raw value being determined as one of said predetermined values.

Of course, the different features, alternatives and embodiments of the invention can be associated with each other according to various combinations, insofar as they are not mutually incompatible or exclusive.

### DETAILED DESCRIPTION OF THE INVENTION

Moreover, various other features of the invention will be apparent from the appended description made with reference to the drawings that illustrate non-limiting embodiments of the invention, and wherein:

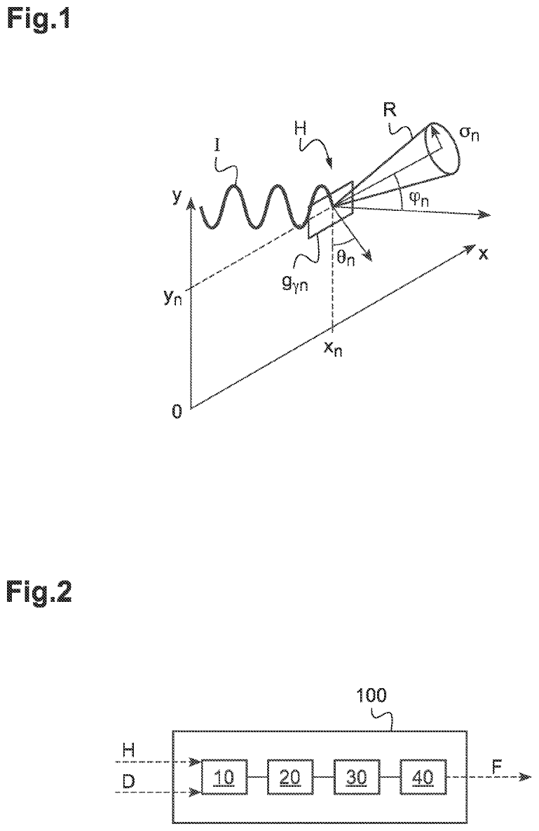

FIG. 1 is a schematic representation of a light beam generated by the diffraction of an incident light wave and corresponding to a decomposition wavelet;

FIG. 2 is a schematic representation of a device for transmitting a digital hologram according to the invention;

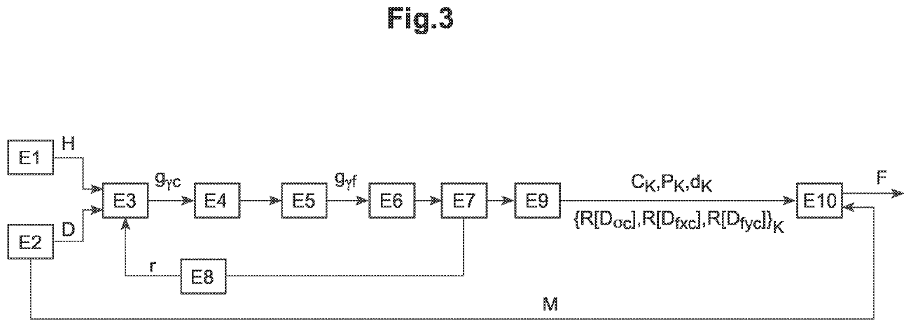

FIG. 3 is a block diagram representing a sequence of steps for transmitting data representing a digital hologram according to the invention;

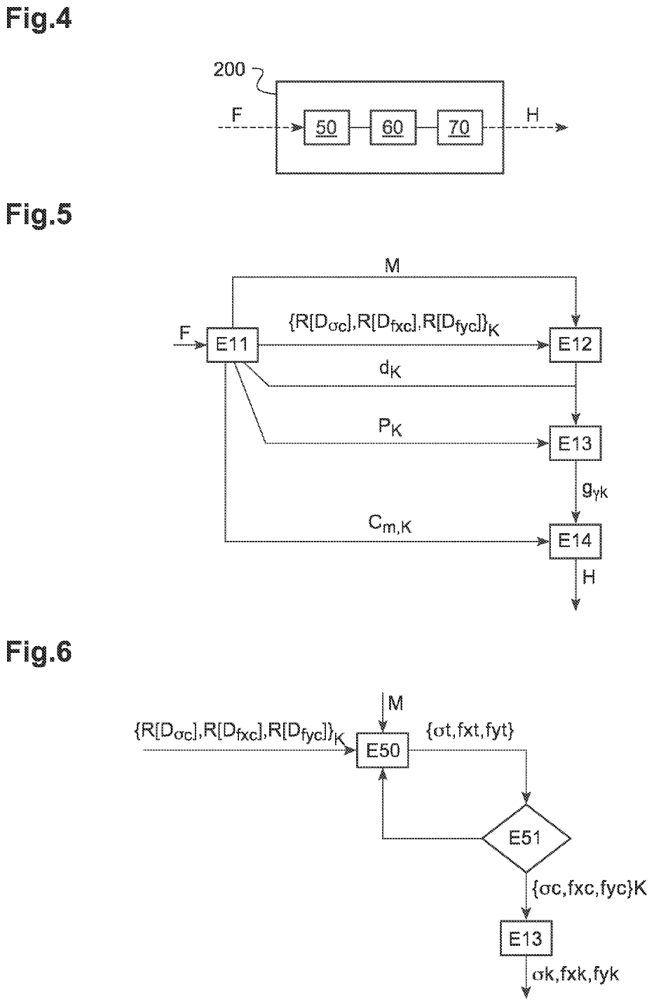

FIG. 4 is a schematic representation of a device for constructing a digital hologram according to the invention;

FIG. 5 is a block diagram representing a sequence of steps for constructing a digital hologram according to the invention; and

FIG. 6 is a block diagram representing a sequence of sub-steps of the block diagram of FIG. 5;

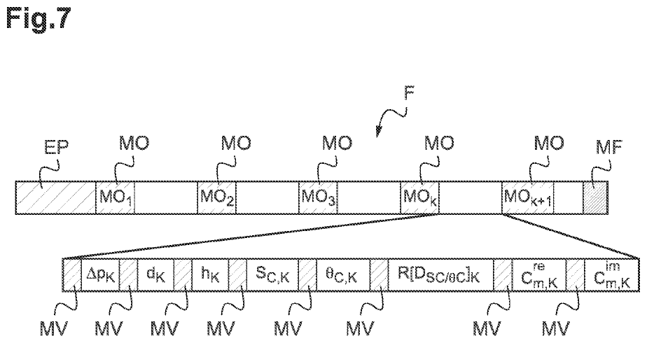

FIG. 7 is a schematic representation of a data flow transmitted by the transmission device of FIG. 2 and received by the construction device of FIG. 4.

In the following, a digital hologram H will be considered.

First, the decomposition of the digital hologram H and the transmission of data representing the digital hologram H according to a first embodiment will be first described.

The steps of the transmission method are here implemented by a transmission device 100. As shown in FIG. 2, the transmission device 100 comprises a decomposition module 10, a scheduling module 20, an encoding module 30 and a transmission module 40.

The decomposition module 10 is designed to determine the data representing the digital hologram H. For that purpose, the decomposition module 10 is based on a dictionary D of decomposition wavelets.

The scheduling module 20 is designed to order the data representing the digital hologram H.

The encoding module 30 is designed to encode the data representing the digital hologram H, here in the order defined by the scheduling module 20, into a data flow to be transmitted. The encoding module 30 is here also designed to encode metadata relating to the dictionary D of decomposition wavelets.

The transmission module 40 is designed to transmit the data flow F prepared by the encoding module 30 on a communication network. As will be described hereinafter, the transmission module 40 here transmit the data flow F on the communication network towards a device 200 for constructing a digital hologram H.

The above-mentioned modules 10, 20, 30, 40 can in practice be implemented by the cooperation of at least one hardware element, such as a processor and a communication circuit, in particular for the transmission module 40, and software elements, such as computer program instructions executable by the above-mentioned processor.

These computer program instructions are here stored in a memory included in the transmission device 100 and to which the processor has access.

These computer-program instructions can in particular be such that the transmission device 100 implements a part at least of the steps described hereinafter with reference to FIG. 3 when these instructions are executed by the processor of the transmission device 100.

Thereafter, when a module 10, 20, 30, 40 carries out an action within the framework of a step of the method, this means that the processor carries out the computer program instructions dedicated to the implementation of this step or a part of this step. The processor, and thus the above-mentioned modules, are thus programmed to carry out the steps described hereinafter with reference to FIG. 3.

FIG. 3 shows the main steps of the method for transmitting data representing the digital hologram H according to the first embodiment.

Step E1

This method starts with step E1 in which the digital hologram H is selected from a holographic database, which is for example stored on a remote server. The digital hologram H is for example received by the transmission device 100 from the remote server. The digital hologram H is here stored in the memory of the transmission device 100. The digital hologram H is here consisted of a two-dimensional matrix of complex numbers. The digital hologram H is here a non-compressed hologram.

Step E2

During a step E2, here carried out in parallel to step E1, a discretized dictionary D of decomposition wavelets is selected from a database, which is for example stored on a remote server. The dictionary D is for example received by the transmission device 100 from the remote server. As an alternative, the dictionary is pre-stored in the memory of the transmission device 100.

As proposed in the article “Color digital hologram compression on the basis of matching pursuit” by A. El Rhammad, P. Gioia, A. Gilles, M. Cagnazzo and B. Pesquet-Popescu in Applied Optics, Vol. 57, n° 17, 10 Jun. 2018, a digital hologram H can be parsimoniously decomposed into a set of decomposition wavelets. Here, the decomposition wavelets are discretized Gabor wavelets g_{γn}. The Gabor wavelets are indeed particularly suitable for digital hologram decomposition because they offer the best compromise of localization in both the spatial and frequency domains. As indicated hereinafter, the decomposition wavelets can however be other types of wavelets such as Morlet wavelets.

Each Gabor wavelet g_{γn}, here generally referred to by the index n is characterized by a group of parameters, called spatial frequency parameters. This group of parameters includes spatial translation parameters, called spatial parameters, here a first spatial parameter xₙ, and a second spatial parameter yₙ and frequency parameters, here a rotation parameter θₙ, a spatial frequency parameter fₙ, and an expansion parameter σₙ. In the literature, the expansion parameter σₙ is also often called dispersion parameter or variance parameter. In this embodiment, the Gabor wavelet g_{γn} is defined by the following formula:

$${g}_{{γ}_{n}} ( x , y ) = exp \{ - \frac{{σ}_{n}}{2} ( {( x - {x}_{n} )}^{2} + \qquad [ Math . 1 ]$$

$${( y - {y}_{n} )}^{2} ) \} exp \{ 2 π {jf}_{n} [ ( x - {x}_{n} ) cos ( {θ}_{n} ) + ( y - {y}_{n} ) sin ( {θ}_{n} ) ] \}$$

As illustrated in FIG. 1, a Gabor wavelet g_{γn} thus corresponds to a diffracted light ray R, stemming from an incident light wave I, at the point of coordinates (xₙ, yₙ) in the plane (xOy) of the digital hologram H and with a direction defined by an azimuth angle equal to the rotation parameter θₙ, a diffraction angle φₙ, and an angular dispersion determined by the expansion parameter σₙ.

The spatial frequency parameters of the wavelet thus show a duality with the diffraction parameters of the diffracted light ray R.

The diffraction angle φₙ is given by the formula φₙ=arcsin(λ·fₙ) where λ is the wavelength of the incident light wave I.

The spatial parameters here relate to the position of the decomposition wavelet in a holographic plane, i.e. the position of emergence of the light ray R diffracted by this wavelet. The frequency parameters here relate to the shape and direction of a light ray R diffracted by the decomposition wavelet.

The discretized dictionary D of decomposition wavelets contains, for each parameter of the group of parameters γₙ, a discrete set of values.

For example, when the resolution of the digital hologram H is N₇N_{y}, with Nₓ and N_{y} predetermined positive integers, the discrete set of values of the spatial parameters xₙ, yₙ consists for example of all the integer values between 1 and Nₓ and N_{y}, respectively.

For the spatial frequency parameter fₙ, the discrete set of values is given for example by the formula fₙ=(t·Δ)⁻¹ where Δ is the spacing between 2 adjacent pixels of the digital hologram H and t an integer between 1 and a predetermined integer T.

For the rotation parameter θₙ, the discrete set of values is given for example by the formula θₙ=p·(2π/P) where p is an integer between 0 and a predetermined integer P.

For the expansion parameter σₙ, the discrete set of values is given for example by the formula σₙ=log(2*log(2)/(π·rₙ² f²ₙ)), where rₙ=α(s) with α an arbitrary linear function and s an integer between 1 and a predetermined integer S.

In the following, the number of decomposition wavelets in the discretized dictionary D of decomposition wavelets will be denoted Nz. The number Nz of wavelets in the dictionary D is given by the product of the number of discrete values for each frequency parameter, i.e. Nz=T*P*S.

Hereinafter, an equivalent representation on the basis of the spatial frequency fₓₙ along direction x and the spatial frequency f_{yn} along direction y will be used for the frequency parameters. fₓₙ is computed according to the formula fₓₙ=fₙ·cos(θₙ) and f_{yn} is computed according to the formula f_{ny}=fₙ·sin(θₙ). The three frequency parameters are thus the expansion σₙ, the spatial frequency along direction x fₓₙ and the spatial frequency along direction y f_{yn}. The more values in the discrete sets, i.e. the more decomposition wavelets in the dictionary, the denser the dictionary.

As will be explained hereinafter, thanks to the transmission device 100, it is possible to finely decompose the digital hologram H while using a dictionary D containing a small number of decomposition wavelets. Using a sparse dictionary D saves storage space and reduces the computation time required for the decomposition of the digital hologram H.

Here, for example, for a digital hologram of resolution 4096×4096, each discrete set for the spatial parameters contains between 1 and 4096 values. In the case where each frequency parameter is discretized over 8 levels, the redundancy of the decomposition is of 8³=512, and Nz=512 decomposition wavelets are contained in the dictionary D.

The dictionary D here contains both the analytic functions that define the decomposition wavelets and that are stored in the memory of the transmission device 100 as computer instructions, and the metadata for determining the discrete sets of values of the spatial frequency parameters.

The operation relating to a particular chromatic component (of wavelength A) of the digital hologram H will now be described. The digital hologram H could however in practice have other chromatic components, each of the chromatic components being then decomposed and transmitted as described hereinafter.

Moreover, the embodiment described herein uses as indicated hereinabove a decomposition by means of Gabor wavelets. It would however be possible, as an alternative, to use other decompositions, for example by means of Morlet wavelets, as described for example in the article “Morlet Wavelet transformed holograms for numerical adaptive viewbased reconstruction”, by K. Viswanathan, P. Gioia and L. Morin, in Proc. SPIE 9216, Optics and 15 Photonics for Information Processing VIII, August 2014, San Diego, United-States.

An iterative decomposition algorithm of the “matching pursuit” type will now be described at steps E3 to E8. The first iteration of this algorithm according to the first embodiment will be described in detail.

Step E3

Once the digital hologram H and the dictionary D selected, during a step E3, the decomposition module 10 determines raw values for the group of above-mentioned parameters.

The raw values of the parameters are here indicated with an index c. When considered as their raw values, the spatial parameters are then denoted x_{c} and y_{c} and the frequency parameters σ_{c}, f_{xc}, f_{yc}. When concerned as their raw values, the group of parameters is then denoted γ_{c} and the Gabor wavelet they characterize, called first wavelet, is denoted g_{γc}.

To determine the raw values of the parameters, the decomposition module 10 searches, among all the discrete values contained in the dictionary D, the values that maximize the modulus of the scalar product between the digital hologram H and the first wavelet g_{γc}. The scalar product operator will be described hereinafter in detail in step E4.

In practice, the decomposition module 10 performs this scalar product a number of times equal to the number of combinations between the discrete sets of each parameter and selects the scalar product whose modulus is the highest. This scalar product is called first scalar product.

The raw values thus define the decomposition wavelet from the dictionary D that is the most representative of the digital hologram H.

Step E3 is a convention step of an iterative decomposition algorithm of the matching pursuit type.

Step E4

Once the raw values x_{c}, y_{c}, σ_{c}, f_{xc}, f_{yc} of the parameters determined, the decomposition module 10 proceeds to a step E4 of refining these raw values.

This refinement is on the basis of an optimization of the scalar product between the digital hologram H and the first wavelet g_{γc}. Theoretically, the optimum of this scalar product is determined by searching the points at which the derivatives relative to each of the parameters are zero. These points are here called the fine values x_{f}, y_{f}, σ_{f}, f_{xf}, f_{yf} of the parameters, indicated with an index f.

The mathematical formulas which the decomposition module 10 uses to compute the fine values x_{f}, y_{f}, σ_{f}, f_{xf}, f_{yf} will be described in the following paragraphs. In the following, the scalar product operator is denoted <.,.>. These formulas are here stored in the memory of the transmission device 100 as computer instructions.

The fine values x_{f}, y_{f}, σ_{f}, f_{xf}, f_{yf} of the parameters characterize a second wavelet g_{γf}. The second wavelet g_{γf} is such that:

<H,g_{γ}_{_{c}}>=a<g_{γ}_{_{f}},g_{γ}_{_{c}}> [Math. 2]

where a is a scalar representing the scalar product between the digital hologram H and the second wavelet g_{γf}.

The analytic formula of the scalar product <g_{γc},g_{γf}> is the following:

<g_{γ}_{_{c}},g_{γ}_{_{f}}>=∫∫g_{γ}_{_{c}}(x,y)g̅_̅{̅γ̅}̅_̅{̅_̅{̅f̅}̅}̅(̅x̅,̅y̅)̅dxdy [Math. 3]

According to the following equation:

$$\frac{\partial }{\partial {γ}_{c}} 〈 H , {g}_{{γ}_{c}} 〉 = 〈 H , \frac{\partial }{\partial {γ}_{c}} {g}_{{γ}_{c}} 〉 \qquad [ Math . 4 ]$$

it is possible to numerically compute the derivative of the scalar product <H,g_{γc}> relative to each parameter.

According to the following equation:

$$\frac{\partial }{\partial {γ}_{c}} 〈 {g}_{{γ}_{f}} , {g}_{{γ}_{c}} 〉 = {ξ}_{{γ}_{c}} 〈 {g}_{{γ}_{f}} , {g}_{{γ}_{c}} 〉 \qquad [ Math . 5 ]$$

it is possible to theoretically compute the derivative of the scalar product <g_{γc},g_{γf}> relative to each of the parameters by exploiting the analytic formulas of the Gabor wavelets given at step E1. In this equation, ξ_{γc} is a function with complex values that depends on the first wavelet g_{γc} and the second wavelet g_{γf}.

By applying the derivative operator to the two terms of the equation [Math. 2], we obtain:

$$\frac{\partial }{\partial {γ}_{c}} 〈 H , {g}_{{γ}_{c}} 〉 = a \frac{\partial }{\partial {γ}_{c}} 〈 {g}_{{γ}_{f}} , {g}_{{γ}_{c}} 〉 \qquad [ Math . 6 ]$$

and thus,

$$\frac{\partial }{\partial {γ}_{c}} 〈 H , {g}_{{γ}_{c}} 〉 = a {ξ}_{{γ}_{c}} 〈 {g}_{{γ}_{f}} , {g}_{{γ}_{c}} 〉 \qquad [ Math . 7 ]$$

We thus obtain:

$${ξ}_{{γ}_{c}} = \frac{〈 H , \frac{\partial }{\partial {γ}_{c}} {g}_{{γ}_{c}} 〉}{〈 H , {g}_{{γ}_{c}} 〉} \qquad [ Math . 8 ]$$

Refinement formulas linking the raw values to the fine values can thus be deduced. For that purpose, we use, on the one hand, the theoretical formula of ξ_{γc}, given by the above equation, and on the other hand, the digital values of the scalar products of the derivatives of <H,g_{γc}> relative to the parameters. These refinement formulas thus allow determining the fine values defining the second wavelet. The second wavelet is then such that its scalar product with the digital hologram H is maximum in modulus.

The expansion parameter refinement formula is the following:

σ_{f}=σ_{c}+log(−1+β) [Math. 9]

with

$$β = ( \frac{( 2 {πσ}_{c} )}{\begin{matrix}{σ}_{c} ( {σ}_{c} ( {ℛ [ {D}_{{x}_{c}} ]}^{2} + {ℛ [ {D}_{{y}_{c}} ]}^{2} ) - 4 π ℛ [ {D}_{{σ}_{c}} ] + π ) - \\ ( ( {ℛ [ {D}_{{f}_{{x}_{c}}} ]}^{2} + {ℛ [ {D}_{{f}_{{y}_{c}}} ]}^{2} )\end{matrix}} ) \qquad [ Math . 10 ]$$

The spatial parameter refinement formulas are the following:

$${x}_{f} = {x}_{c} + \frac{{σ}_{c} + {σ}_{f}}{2 π} ℛ [ {D}_{{x}_{c}} ] \qquad [ Math . 11 ]$$

$$and$$

$${y}_{f} = {y}_{c} + \frac{{σ}_{c} + {σ}_{f}}{2 π} ℛ [ {D}_{{y}_{c}} ] \qquad [ Math . 12 ]$$

The frequency parameter refinement formulas are the following:

$${f}_{{x}_{f}} = {f}_{{x}_{c}} + \frac{{σ}_{c}^{- 1} + {σ}_{f}^{- 1}}{2 π} ℛ [ {D}_{{f}_{{x}_{c}}} ] \qquad [ Math . 13 ]$$

$$and$$

$${f}_{{y}_{f}} = {f}_{{y}_{c}} + \frac{{σ}_{c}^{- 1} + {σ}_{f}^{- 1}}{2 π} ℛ [ {D}_{{f}_{{y}_{c}}} ] \qquad [ Math . 14 ]$$

The notation R[.] represents the real part of the elements between brackets.

The refinement formulas here involve scalar products of derivation D_{xc}, D_{yc}, D_{σC}, D_{fxc}, D_{fyc}. Each scalar product of derivation here represents a scalar product between the hologram H and a derivative of the first wavelet relative to one of the parameters. The refinement formulas thus involve a scalar product of derivation D_{xc} for the first spatial parameter, a scalar product of derivation D_{xy} for the second spatial parameter, a scalar product of derivation D_{σc} for the expansion parameter, a scalar product of derivation D_{fxc} for the frequency parameter along x and a scalar product of derivation D_{fxy} of the frequency parameter along y.

The general formula of a scalar product of derivation is the following:

$${D}_{{γ}_{c}} = \frac{〈 H , \frac{\partial }{\partial {γ}_{c}} {g}_{{γ}_{c}} 〉}{〈 H , {g}_{{γ}_{c}} 〉} \qquad [ Math . 15 ]$$

where D_{γc} represents one of the scalar products of derivation, the derivative δγ_{c} represents the derivative relative to one of the parameters, and g_{γc} represents the first wavelet defined by the raw values x_{c}, y_{c}, σ_{c}, f_{xc}, f_{yc}.

The notations D_{γc} and ξ_{yc} both represent the scalar product of derivation, however D_{γc} is numerically computed, whereas ξ_{yc} is theoretically computed.

The sub-steps carried out by the decomposition module 10 during step E4 will now be described.

In a first sub-step, the decomposition module 10 numerically compute the scalar products of derivation D_{xc}, D_{yc}, D_{σc}, D_{fxc}, D_{fyc}, according to the above formula. For that purpose, the decomposition module 10 uses for example analytic formulas of the derivatives of the first wavelet relative to the parameters that are stored in the memory of the transmission device 100. The decomposition module 10 applies the raw values determined at step E3 to these stored formulas, then carries out the scalar products with the digital hologram H.

In a second sub-step, the decomposition module 10 computes, on the basis of the refinement formulas, the fine values. It first computes the fine value σ_{f} of the expansion parameter. Then, it computes the fine values of the two other frequency parameters f_{xf}, f_{yf} and the two spatial parameters x_{f}, y_{f}.

The decomposition module 10 computes more specifically the fine values on the basis of the real parts of the scalar products of derivation.

Therefore, as shown by the refinement formulas, for each parameter, the decomposition module 10 determines the fine values by combining the raw values with refinement values. The refinement values are here determined as a function of the real part of the scalar product of derivation associated with the concerned parameter, as visible in the above refinement formulas. The refinement values for the parameters other than the expansion parameter are here determined also as a function of the fine value of the expansion parameter. The refinement values are thus the terms added on the right of the sum in the refinement formulas, i.e. the terms added to the raw values to compute the fine values.

With this step E4, the decomposition module 10 thus determines the second decomposition wavelet g_{γf} that is generally more representative of the digital hologram H than the first wavelet g_{γc}. Indeed, the determination of the first wavelet g_{γc} is limited by the discrete values, from the dictionary D, that can be taken by the raw values, whereas the fine values are determined over continuous sets.

As described hereinabove, this refinement step has several advantages, in particular obtaining fine decompositions, i.e. here of high quality, on the basis of a sparse dictionary, and thus reducing the computation time required for the decomposition.

To accelerate the carrying out of step E4, the decomposition module 10 can numerically compute only the scalar products of derivation D_{xc}, D_{yc}, D_{σc} for the spatial parameters and the expansion parameters. Then, it computes the real parts of the scalar products of derivation D_{fxc}, D_{fyc} of the frequency parameters thanks to the following relations:

$$ℛ [ {D}_{{f}_{{x}_{c}}} ] = [ I [ {D}_{{x}_{c}} ] - 2 π {f}_{{x}_{c}} cos ( {θ}_{c} ) ] {σ}_{c} \qquad [ Math . 16 ]$$

$$and$$

$$ℛ [ {D}_{{f}_{{y}_{c}}} ] = [ I [ {D}_{{y}_{c}} ] - 2 π {f}_{{y}_{c}} sin ( {θ}_{c} ) ] {σ}_{c} \qquad [ Math . 17 ]$$

The notation I[.] represents the imaginary part of the elements between brackets.

Step E5

Remarkably, the decomposition method here comprises, once the decomposition module 10 has computed the scalar products of derivation, a step of quantifying fine values and refinement values.

During step E5, the quantification module 20 quantifies in particular the real parts of the scalar products of derivation, which are here generally denoted R[D_{yc}].

Here, during step E4, the fine values are computed on the basis of the quantified real parts of the scalar products of derivation R[D_{yc}].

Step E5 thus constitutes an anticipated quantification, for the purpose of transmission, of certain data representing the digital hologram H.

The applicant has indeed observed that quantifying the fine values during their determination at step E4, i.e. during the iterations of the decomposition method of the matching pursuit type, makes it possible to reduce the errors linked to quantification at each iteration, i.e. compensating for them as they occur.

Here, the quantification module 20 implements a Lloyd Max quantifier, for example over 16 levels or 32 levels.

Step E6

Once the decomposition module 10 has computed the fine values x_{f}, y_{f}, σ_{f}, f_{xf}, f_{yf} of the parameters, the decomposition module 10 determines a fine coefficient c_{f} on the basis of a second scalar product between the digital hologram H and the second wavelet g_{γf}.

The decomposition module 10 more specifically computes the fine coefficient c_{f} as being equal to the value of the second scalar product, i.e. according to the formula c_{f}=<H,g_{γf}>.

Step E7

Here, during a step E7, the decomposition module 10 also compute a raw coefficient cc as being equal to the value of the scalar product between the digital hologram H and the first wavelet g_{γc}, i.e. according to the formula c_{c}=<H,g_{γc}>.

The decomposition module 10 then compares the modulus of the raw coefficient c_{c} with the modulus of the fine coefficient c_{f}. The decomposition module 10 thus compares the second scalar product between the digital hologram H and the second wavelet g_{γf} with the scalar product between the digital hologram H and the first wavelet g_{γc}.

The decomposition module 10 then generates a decision d relating to this comparison. Here, the decision d is equal to 1 when the modulus of the fine coefficient c_{f} is higher than or equal to the modulus of the raw coefficient cc and equal to 0 when the modulus of the fine coefficient c_{f} is lower than the modulus of the raw coefficient c_{c}.

A modulus of a fine coefficient c_{f} higher than a modulus of a raw coefficient cc means that the second wavelet g_{γf} is more representative of the digital hologram H than the first wavelet g_{γc}, and vice-versa. In practice, in most cases, the modulus of the fine coefficient c_{f} is higher than the modulus of the raw coefficient c_{c}.

The decomposition module 10 determines a memorized coefficient cₘ and a memorized wavelet g_{γm}.

When the modulus of the fine coefficient c_{f} is higher than or equal to the modulus of the raw coefficient c_{c}, the memorized coefficient cₘ is equal to the fine coefficient c_{f} and the memorized wavelet g_{γm} is equal to the second wavelet g_{γf}.

When the modulus of the fine coefficient c_{f} is lower than the modulus of the raw coefficient c_{c}, the memorized coefficient cₘ is equal to the raw coefficient c_{c} and the memorized wavelet g_{γm} is equal to the first wavelet g_{γc}.

The fine coefficient c_{f}, the raw coefficient c_{c} and the memorized coefficient cₘ are here complex numbers.

The decision d thus makes it possible to keep in memory which decomposition wavelet, from the first wavelet and the second wavelet, is actually used to decompose the digital hologram H during an iteration.

Step E8

The decomposition module 10 then determines a residue r on the basis of the digital hologram H, of the memorized coefficient cₘ and the memorized wavelet g_{γm}. The residue is here computed according to the formula r=H—cₘ·g_{γm}.

The computation of the residue r is a conventional step in an algorithm of the matching pursuit type. During successive iterations of steps E3 to E8, which are not described in detail here, the operations implemented during these steps are carried out on the residue r instead of the digital hologram H and the residue is updated at the end of each step E8.

For example, for a residue r, the first equation described at step E4 is generalized by the following equation:

<r,g_{γ}_{_{c}}>=a<g_{γ}_{_{f}},g_{γ}_{_{c}}> [Math. 18]

During an iteration K, the residue r is updated according to the following formula: r_{K+1}=r_{K}—c_{m,K}·g_{γm,K}, where c_{m,K} represents the memorized coefficient determined at step E7 of iteration K and where g_{γm,K} represents the memorized wavelet determined at step E7 of iteration K.

Here, steps E3 to E8 are iterated a predetermined number of times. Steps E3 to E8 are here iterated L times, L being a positive integer.

Here, the number of iterations L is determined either by a flow rate criterion or by a quality criterion. With the flow rate criterion, the iterations are stopped when a predetermined maximum flow rate of the flow to be encoded is reached. With the quality criterion, the iterations are stopped when the norm of the residue is smaller than a predetermined threshold value.

As an alternative, steps E3 to E8 could be iterated a predetermined number of times. As an alternative, steps E3 to E8 could be iterated for a predetermined duration or until the later memorized coefficient is lower than a predetermined threshold value.

After having carried out L iterations, the decomposition module 10 has in particular determined the following data, which represent the digital hologram H: L groups of raw values, L groups of fine values, L memorized coefficients and L decisions.

As explained hereinabove, the implementation at steps E3 to E8 enables an accurate decomposition of the digital hologram H, even on the basis of a sparse dictionary D. The values of the parameters being refined, this also allows reducing the number of wavelets to be extracted (and thus the computation time) for a given quality of decomposition.

A method for encoding data representing the digital hologram H according to the first embodiment will now be described. This method, which is in particular implemented by the encoding module 30, is particularly adapted to the decomposition presented hereinabove. This method allows encoding and transmitting a data flow F containing the minimum of information required for the construction of the digital hologram H by the construction device 200, which is also adapted for this decomposition, and which is represented in FIG. 4.

Step E9

Previously to the encoding, in order to limit the quantity of data to be transmitted, the scheduling module 20 orders the data representing the digital hologram H from each iteration into a line-by-line scanning scheme, better known as “raster scan” scheduling. Here, the scheduling module 20 orders only the data that are encoded and transmitted.

The scheduling is performed on the basis of the spatial parameters. Thereafter, the scheduling indices stemming from the scheduling are applied to the frequency parameters, the coefficients and the decisions.

Given that the memorized wavelets are extracted in the decreasing order of the scalar product amplitude (the most representative wavelet is determined first), the encoding of the spatial position in this order is very expensive. The “raster scan” scheduling makes it possible to remedy this by differentially encoding the values of the spatial parameters. During the raster scan scheduling, the values of the spatial parameters corresponding to the first wavelet met are encoded. Then, the spatial difference between the second wavelet met and the first one is encoded, and so one.

Step E10

During a step E10, data representative of the hologram H are encoded and transmitted. Step E10 makes it possible to generate a data flow containing sufficient information for constructing the digital hologram H. The sufficient information for constructing the digital hologram H will now be described.

First, during a sub-step of step E10, the encoding module 30 quantifies the data that are intended to be encoded. Here, the encoding module 30 implements a Lloyd Max quantifier.

The encoding method is characterized by an encoding rate. The encoding rate here is in particular the sum of a rate for encoding the parameter values, a rate for encoding the memorized coefficients and a rate for encoding the decisions. The encoding rate here corresponds to a number of bits required for encoding the data, here in binary form.

In order to reduce the rate at which parameter values are encoded, the encoding module 30 encodes, for the frequency parameters, only the real parts of the scalar products for derivation. In FIG. 3, the groups of values encoded for the frequency parameters are represented by the notation {R[D_{σc}], R[D_{fxc}], R[D_{fyc}]}_{K}, where the index K corresponds to one of the iterations of the decomposition.

Indeed, as described in detail in the construction part of the digital hologram H, it is possible, for the frequency parameters, to determine, from a triplet of real parts of the scalar products of derivation, the triplet of raw values having served to obtain it during the decomposition and thus the triplet of fine values associated with this triplet of real parts of the scalar products of derivation.

The applicant has also observed that the refinement values of the spatial parameters are negligible with respect to the raw values. In other words, the fine values x_{f}, y_{f} of the spatial parameters are substantially equal to the raw values x_{c}, y_{c}.

Moreover, the expansion parameter refinement formula can be approximated by computing β as follows:

$$β = ( \frac{2 {πσ}_{c}}{{σ}_{c} ( - 4 π ℛ [ {D}_{{σ}_{c}} ] + π ) - ( {ℛ [ {D}_{{f}_{{x}_{c}}} ]}^{2} + {ℛ [ {D}_{{f}_{{y}_{c}}} ]}^{2} )} ) \qquad [ Math . 19 ]$$

The term corresponding to the real parts of the scalar products of derivation of the spatial parameters is indeed negligible compared to the other terms of the denominator.

This means that the scalar products of derivation of the spatial parameters are not necessary for the construction of the digital hologram H by the construction device 200.

For the spatial parameters, it is therefore provided to encode and transmit only the raw values x_{c}, y_{c}.

The fact to limit the encoding of the parameter values to the real parts of the scalar products of derivation of the frequency parameters R[D_{σc}], R[D_{fxc}], R[D_{fyc}] and to the raw values x_{c}, y_{c} for the spatial parameters makes it possible to reduce the rate for encoding the values of the parameters and thus the encoding rate.

During step E10, the encoding module 30 thus here encodes into a data flow F:
i) the memorized coefficients, grouped under the notation C_{m,K},
ii) positions, grouped under the notation p_{K}, formed of the raw values of the spatial parameters, and
iii) the real parts of the scalar products of derivation for the frequency parameters, grouped under the notation {R[D_{σc}], R[D_{fxc}], R[D_{fyc}]}_{K},
iv) the decisions, grouped under the notation d_{K}.

A position p is defined relating to the raw values x_{c}, y_{c} of the spatial parameters according to the following formula p=(y_{c}−1)*Nx+x_{c} where Nx is the spatial resolution of the digital hologram H along direction x.

Thanks to the scheduling module 20, the position encoding rate is reduced by differentially encoding the wavelet positions after the raster scan scheduling.

As shown in FIG. 3, the encoding module 30 here encodes in the data flow F metadata M representing discrete sets of values for the frequency parameters. It is indeed not necessary to transmit metadata representing the discrete sets of values for the spatial parameters because the raw values of the spatial parameters are transmitted.

These metadata M comprise for example the formulas, presented with Step E2, for determining the discrete sets, as well as the analytic formula of the Gabor wavelets and their derivatives relative to the parameters.

As an alternative, the encoding module could not transmit metadata. The construction device receiving the data flow could for example be designed to construct specifically digital holograms decomposed on the basis of the dictionary used by the decomposition device.

Here, the encoding module 30 implements an entropic encoding to generate the data flow F. The data flow F is here a sequence of binary elements.

Thereafter, the transmission module 40 transmits the data flow F, here to the construction device 200. The transmission is made by means of a communication network, for example Internet, through a wire connection or a wireless connection.

The construction of the hologram H on the basis of the data transmitted within the framework of the first embodiment will now be described.

The steps of the construction method are here implemented by the construction device 200, which is specifically designed to construct the digital hologram H on the basis of the data flow F. As shown in FIG. 4, the transmission device 200 comprises a reception module 50, a decoding module 60 and a construction module 70.

The reception module 50 is designed to receive the data flow F and to send it to the decoding module 60.

The decomposition module 60 is designed to decode the data flow F and to extract the data representing the digital hologram H.

The construction module 70 is designed to construct the digital hologram H on the basis of the data representing the digital hologram H extracted by the decoding module 60.

The above-mentioned modules 50, 60, 70 of the construction device 200 can in practice be implemented by the cooperation of at least one hardware element, such as a processor and a communication circuit, in particular for the reception module 50, and software elements, such as computer program instructions executable by the above-mentioned processor.

These computer program instructions are here stored in a memory included in the construction device 200 and to which the processor can have access.

These computer-program instructions can in particular be such that the transmission device 200 implements a part at least of the steps described hereinafter with reference to FIG. 5 when these instructions are executed by the processor of the transmission device 200.

Thereafter, when a module 50, 60, 70 of the construction device 200 carries out an action within the framework of a step of the method, this means that the processor carries out the computer program instructions dedicated to the implementation of this step or a part of this step. The processor, and thus the above-mentioned modules, are thus programmed to carry out the steps described hereinafter with reference to FIG. 5.

FIG. 5 shows the main steps of the method for constructing the digital hologram H according to the first embodiment.

Step E11

The construction method starts with a step E11 in which the reception module 50 receives the data flow F and transmits it to the decoding module 60.

The decoding module 60 decodes the data representative of the digital hologram H. The decoding module 60 here decodes the data that are encoded at step E10 of the transmission method. As shown in FIG. 5, this here means that the decoding module 60 extracts from the data flow F:
i) the memorized coefficients,
ii) the positions,
iii) the real parts of the scalar products of derivation for the frequency parameters,
iv) the decisions, and
v) the metadata M.

The data extracted by the decoding module 60 are grouped by packets, a packet containing all the data from a same iteration of the decomposition method. En other words, the decomposition module determines which memorized coefficient, position and decision are associated to a given triplet of real parts of the scalar products of derivation for the frequency parameters {R[D_{σc}], R[D_{fxc}], R[D_{fyc}]}.

In FIG. 5, all the terms having the index K are from the iteration number K of the decomposition method. Thus, the real parts of the scalar products of derivation for the frequency parameters {R[D_{σc}], R[D_{fxc}], R[D_{fyc}]}_{K} are associated with the position p_{K}, the decision d_{K} and the memorized coefficient C_{m,K}.

Step E12

Once the data representing the digital hologram H extracted, the decoding module 60 determines from which raw values derive the real parts of the scalar products of derivation of the frequency parameters.

For that purpose, the decoding module 60 determines, for each triplet of real parts of the scalar products of derivation for the frequency parameters {R[D_{σc}], R[D_{fxc}], R[D_{fyc}]}, the triplet of raw values {σ_{c}, f_{xc}, f_{yc}} that has served as a basis, during an iteration of step E4 of the decomposition method, for determining this triplet of real parts of the scalar products of derivation for the frequency parameters {R[D_{σc}], R[D_{fxc}], R[D_{fyc}]}. As the decomposition has been made in L iterations, the decoding module 60 thus determines here L triplets of raw values.

Here, in a sub-step of step E12, the decoding module 60 determines, on the basis of the metadata M and for each frequency parameter, the discrete set of values from the dictionary D. The decoding module 60 uses for example the formulas presented at step E2 and whose parameters are transmitted via the metadata M.

As an alternative, the decoding module could be designed to process only digital holograms decomposed on the basis of the dictionary D. The discrete sets could for example be pre-stored in the memory of the construction device.

The way the decomposition module 60 carries out step E12, as well as a following step E13, for a triplet of real parts of the scalar products of derivation for the frequency parameters {R[D_{σc}], R[D_{fxc}], R[D_{fyc}]}_{K} stemming from iteration K, among the L iterations, of the decomposition method, will now be described. In practice, the decomposition module 60 carries out the steps E12 and E13 for all the triplets, i.e. for the L triplets, of real parts of the scalar products of derivation for the frequency parameters.

The decomposition module 60 first determines a triplet of raw values associated with this triplet of real parts of the scalar products of derivation for the frequency parameters {R[D_{σc}], R[D_{fxc}], R[D_{fyc}]}_{K}.

For that purpose, as shown in FIG. 6, the decomposition module 60 tests, iteratively, all the triplets of the raw values that can be defined on the basis of the discrete sets of values. The decomposition module 60 thus tests iteratively Nz triplets of raw values that correspond to all the composition wavelets initially contained in the dictionary D.

Here, all these triplets of raw values are determined on the basis of the metadata M. The decomposition module 60 thus considers one triplet of raw value per test. FIG. 6 shows the set of tests carried out for a triplet of real parts of the scalar products of derivation for the frequency parameters {R[D_{σc}], R[D_{fxc}], R[D_{fyc}]}_{K}.

In a first sub-step E50 of step E12, the decomposition module 60 determines, on the basis of the triplet of raw values considered and of the scalar products of derivation for the frequency parameters, test values σₜ, fₓₜ, f_{yt}.

The decomposition module 60 first computes, on the basis of the raw value considered for the expansion parameter and the scalar products of derivation for the frequency parameters, a test value of the expansion parameter σₜ. It computes this test values for the expansion parameter σₜ in accordance with the refinement formula presented at step E4 and to the approximated formula of β presented at step E10.

The decomposition module 60 first computes, on the basis of the raw value considered for the spatial frequency parameter along direction x, of the test value for the expansion parameter σₜ and the scalar products of derivation for the frequency parameters, a test value fₓₜ for the spatial frequency parameter along direction x. It computes this test value fₓₜ for the spatial frequency parameter along direction x in accordance with the refinement formula presented at step E4.

The decomposition module 60 finally computes a test value f_{yt} for the spatial frequency parameter along direction y in the same way as for the spatial frequency parameter along direction x.

Then, during a second sub-step E51 of step E12, the decomposition module 60 checks if the computed triplet of test values {σₜ, fₓₜ, f_{yt}} checks the following check equations:

$$ℛ [ {D}_{{f}_{{x}_{c}}} ] = [ \frac{2 π ( {σ}_{f} {f}_{{x}_{t}} + {σ}_{c} {f}_{{x}_{c}} )}{{σ}_{t} + {σ}_{c}} - 2 π {f}_{{x}_{c}} ] {σ}_{c} \qquad [ Math . 20 ]$$

$$and$$

$$ℛ [ {D}_{{f}_{{y}_{c}}} ] = [ \frac{2 π ( {σ}_{f} {f}_{{y}_{t}} + {σ}_{c} {f}_{{y}_{c}} )}{{σ}_{t} + {σ}_{c}} - 2 π {f}_{{y}_{c}} ] {σ}_{c} \qquad [ Math . 21 ]$$

In the two above check equations, the terms σ_{c}, f_{xc} et f_{xy} represent the raw values considered during this test.

In a first case, when the considered triplet of raw values does not satisfy the two above equations, the decoding module 60 tests another triplet of raw values. In FIG. 6, this first case is represented by the arrow going from step E51 to step E50.

In a second case, when the considered triplet of raw values satisfies the two above equations, the decoding module 60 evaluates that the considered triplet of raw values {σ_{c}, f_{xc}, f_{yc}}_{K} is that from which the triplet of real parts of the scalar products of derivation for the frequency parameters {R[D_{σc}], R[D_{fxc}], R[D_{fyc}]}_{K} is derived.

In this second case, the decoding module 60 stops its iterative test for this triplet of real parts of the scalar products of derivation for the frequency parameters {R[D_{σc}], R[D_{fxc}], R[D_{fyc}]}_{K}.

In this second case, the decoding module 60 keeps this considered triplet of raw values {σ_{c}, f_{xc}, f_{yc}}_{K} for step E13. In FIG. 6, this second case is represented by the arrow going from step E50 to step E13.

When no computed triplet of test values {σₜ, fₓₜ, f_{yt}} satisfies the check equations, the considered triplet of raw values {σ_{c}, f_{xc}, f_{yc}}_{K} that is kept of step E13 is that which satisfies at best the check equations, i.e. that for which the differences between the members of the equalities are the smallest.

Step E13

Once the considered triplet of raw values {lac, f_{xc}, f_{yc}}_{K} determined, during a step E13, the decoding module 60 determines a third decomposition wavelet g_{γK} called the construction wavelet. This wavelet is characterized by a group γ_{K} of construction values x_{K}, y_{K}, σ_{K}, f_{xK}, f_{yK} allocated to the spatial and frequency parameters.

For that purpose, the decoding module 60 here takes into account the decision d_{K} associated with this triplet of real parts of the scalar products of derivation for the frequency parameters {R[D_{σc}], R[D_{fxc}], R[D_{fyc}]}_{K}.

When the decision d_{K} indicates that the wavelet memorized at the iteration number K of the decomposition method is the second wavelet characterized by the fine values, i.e. here when the decision d_{K} is equal to 1, the decoding module 60 determines the construction values σ_{K}, f_{xK}, f_{yK} of the frequency parameters as being equal to the test values {σₜ, fₓₜ, f_{yt}}_{K} that have satisfied the check equations at step E12. This triplet of test values {σₜ, fₓₜ, f_{yt}}_{K} is that which stems from the considered triplet of raw values {σ_{c}, f_{xc}, f_{yc}}_{K} determined at step E12. In other words, the decoding module 60 finds the fine values of the frequency parameters stemming from iteration K of the decomposition method and characterizes the construction wavelet g_{γK} on the basis of these fine values.

This means that, when the decision d_{K} indicates that the wavelet memorized at the iteration number K of the decomposition method is the second wavelet characterized by the fine values, for the frequency parameters, the construction values σ_{K}, f_{xK}, f_{yK} for the triplet of real parts of the scalar products of derivation for the frequency parameters {R[D_{σc}], R[D_{fxc}], R[D_{fyc}]}_{K} are then substantially equal to the fine values σ_{f}, f_{xf}, f_{yf} stemming from iteration K. It is here meant by “substantially equal” that these values are equal to each other, to within the above-described approximation of the parameter β.

When the decision d_{K} indicates that the wavelet memorized at the iteration number K of the decomposition method is the first wavelet characterized by the raw values, i.e. here when the decision d_{K} is equal to 0, the decoding module 60 determines the construction values σ_{K}, f_{xK}, f_{yK} as being equal to the considered raw values {σ_{c}, f_{xc}, f_{yc}}_{K} determined at step E12. In other words, the decoding module 60 then uses the raw values of the frequency parameters stemming from iteration K of the decomposition method and characterizes the construction wavelet g_{γK} on the basis of these raw values.

Whatever the decision d_{K}, the decoding module 60 determines the construction values x_{K}, y_{K} of the spatial parameters on the basis of the position p_{K}. Here, the construction values x_{K}, y_{K} of the spatial parameters are more specifically equal to the position p_{K}. That means that the decoding module 60 uses the raw values of the spatial parameters, determined during the decomposition, to characterize the construction wavelet g_{γK}.

Once the steps E12 and E13 applied to all the triplets of real parts of the scalar products of derivation of the frequency parameters {R[D_{σc}], R[D_{fxc}], R[D_{fyc}]}_{K}, i.e. here applied L times, the decoding module 60 has thus determined L construction wavelets g_{γK}.

Step E14

Once determined, the construction wavelets g_{γK} are sent to the construction module 70.

During a step E14, the construction module 70 computes the digital hologram H by summing the contribution of the different construction wavelets weighted by their associated memorized coefficient. The memorized coefficient associated with a construction wavelet is that which is associated with the triplet of real parts of the scalar products of derivation for the frequency parameters and with the decision having served to determine the construction wavelet.

The construction module 70 thus determines the digital hologram H by performing the sum Σc_{m,K}·g_{γK} for K from 1 to L, i.e. for the L construction wavelets. The construction module 70 the constructs the digital hologram H by performing the sum of the construction wavelets g_{γK} weighted by their associated memorized coefficient c_{m,K}.

As shown in FIG. 4, the construction device 200 here comprises a display module 80 designed to display the hologram H constructed as indicated hereinabove by the construction module 70.

The display module 80 comprises for example a Spatial Light Modulator, SLM, that is possibly integrated in a head-mounted display, for example an augmented reality head-mounted display.

A second embodiment of the decomposition, transmission, reception and construction of the digital hologram H will now be described. The elements of the second embodiment that are different from the first embodiment will be here described in detail. Thus, in this respect, the transmission device 100 and the construction device 200 comprise the same modules as in the first embodiment. The steps of selecting the digital hologram (corresponding to step E1) and summing the construction wavelets (corresponding to step E14) are also identical to those of the first embodiment.

The idea of this second embodiment is to use another definition of the Gabor wavelets in which the Gabor wavelets are defined by a group of only four parameters (instead of five in the first embodiment). This second embodiment makes it possible to further reduce the quantity of data to be processed and transmitted.

In this second embodiment, each Gabor wavelet is defined by the following formula:

$${g}_{{γ}_{n}} ( x , y ) = \frac{1}{\sqrt{π} {s}_{n}} exp ( - \frac{{( x - {x}_{n} )}^{2} + {( y - {y}_{n} )}^{2}}{2 {s}_{n}^{2}} ) exp ( \frac{i π ( ( x - {x}_{n} ) cos ( {θ}_{n} ) + ( y - {y}_{n} ) sin ( {θ}_{n} ) )}{{s}_{n}} ) \qquad [ Math . 22 ]$$

Thus, the Gabor wavelets g_{γn} are defined by a group of parameters that includes four spatial frequency parameters: the first spatial parameter, the second spatial parameter, the rotation parameter, and a second expansion parameter, denoted sₙ. In the following of the disclosure, the expansion parameter σₙ (often called the dispersion or variance parameter in the literature), which is described in the first embodiment is called the first expansion parameter σₙ.

With respect to the first embodiment, the second expansion parameter sₙ is a frequency parameter that correlates the spatial frequency parameter fₙ, and the first expansion parameter σₙ; the relations between these parameters are for example the following: σₙ=1/sₙ² et fₙ=1/(2sₙ).

For the first spatial parameter, the second spatial parameter and the rotation parameter, the discrete sets of values are for example given by the formulas described in the first embodiment.

For the second expansion parameter sₙ, the discrete set of values is for example given by the formula sₙ=2^{β(n)} with β(n)=τ*n, where n is a strictly positive integer and τ a strictly positive real number.

In the second embodiment, the step of determining the raw values (corresponding to step E3) is identical to that of the first embodiment except that, in this second embodiment, are determined the raw values for the group of above-mentioned parameters. With reference to the refinement formulas hereinafter, the raw values are denoted θ_{c} for the rotation parameter and s_{c} for the second expansion parameter.

Here also, the raw values are determined by maximizing the modulus of the scalar product between the digital hologram and the first wavelet that is characterized by the raw values. Here also, each raw value is determined as one of the predetermined values belonging to its discrete set of values.

In the second embodiment, the step of determining the fine values also comprises refining the raw values. The mathematic formulas on which is based the decomposition module 10 for computing the fine values are here also the formulas Math. 2 to Math. 8. With reference to the refinement formulas hereinafter, the fine values are denoted θ_{f} for the rotation parameter and s_{f} for the second expansion parameter.

The scalar product of derivation for the rotation parameter, denoted D_{θc}, and the scalar product of derivation for the second expansion parameter, denoted D_{sc}, are also calculated according to formula Math. 15.

Preferably, the second expansion parameter refinement formula is the following:

$${s}_{f} = \sqrt{\frac{α + γ + 2}{γ - α}} {s}_{c} \qquad [ Math . 23 ]$$

$$with$$

$$α = - 1 + {s}_{c} R [ {D}_{{s}_{c}} ] \qquad [ Math . 24 ]$$

$$and$$

$$γ = \frac{π}{2} \qquad [ Math . 25 ]$$

It will be noted that the above refinement formula of the second expansion parameter is an approached formula obtained after simplification of the theoretical refinement value computing formulas (Math. 5 to Math. 8). As described hereinafter, a refinement formula of higher order, i.e. less simplified, can for example be obtained thanks to formulas Math. 31 and Math. 32.

The spatial parameter refinement formulas are the following:

x_{f}=x_{c}+(s_{c}²+s_{f}²)R[Dₓ_{_{c}}] [Math. 27]

and

x_{f}=x_{c}+(s_{c}²+s_{f}²)R[Dₓ_{_{c}}] [Math. 28]

The rotation parameter refinement formula is the following:

$${θ}_{f} = {θ}_{c} + {sin}^{- 1} ( \frac{{s}_{c}^{2} + {s}_{f}^{2}}{{π}^{2} {s}_{c} {s}_{f}} R [ {D}_{{θ}_{c}} ] ) \qquad [ Math . 29 ]$$

As in the first embodiment, for the four spatial frequency parameters, the decomposition module 10 first computes the scalar products of derivation then the fine values are computed thanks to the refinement formulas.

In this second embodiment, a hybrid refinement corresponding to a refinement according to either one of the frequency parameters, i.e. either according to the rotation parameter or according to the second expansion parameter, is preferably applied.

For that purpose, the decomposition module 10 performs the comparison between:
i) a scalar product, denoted Pₛ, between the hologram (or the residue during the iterations following the first iteration) and a wavelet characterized by the fine value of the second expansion parameter and the raw values for the other parameters (spatial parameters and rotation parameter); and
ii) a scalar product, denoted P_{θ}, between the hologram (or the residue during the iterations following the first iteration) and a wavelet characterized by the fine value of the rotation parameter and the raw values for the other parameters (spatial parameters and second expansion parameter).

The considered wavelets are here defined by the raw values of the spatial parameters. Indeed, as detailed in the first embodiment, the refinement values of the spatial parameters are negligible with respect to the raw values. Also in the second embodiment, the values transmitted by the transmission module 40 for the spatial parameters are the raw values, they are thus already taken into account during the decomposition.

When the modulus of Pₛ is strictly higher than the modulus of P_{θ}, the decomposition module 10 determines, for this iteration of the decomposition, the second wavelet as the wavelet characterized by the fine value of the second expansion parameter and the raw values for the other parameters.

When the modulus of Pₛ is lower than or equal to the modulus of P_{θ}, the decomposition module 10 determines, for this iteration of the decomposition, the second wavelet as the wavelet characterized by the fine value of the rotation parameter and the raw values for the other parameters.

The decomposition module 10 also generates a choice relating to this comparison. The choice is thus representative of the result of this comparison in the sense that it makes it possible to encode whether the modulus of Pₛ is strictly higher or no than the modulus of P_{θ}. In other words, the choice is here representative of the sign (positive, negative or null) of the difference between the modulus of Pₛ and the modulus of P_{θ}. Here, the choice is equal to 1 when the modulus of Pₛ is strictly higher than the modulus of P_{θ} and equal to 0 when the modulus of Pₛ is lower than or equal to the modulus of P_{θ}.

This hybrid refinement (either according to the second expansion parameter or according to the rotation parameter) allows, thereafter, to transmit only the real part of the scalar product of derivation for the parameter according to which the refinement has been made. Therefore, the quantity of data to be transmitted is reduced (as the choice can be encoded on only 1 bit).

In this second embodiment, the quantification module 20 also carries out an anticipated quantification (corresponding to step E5), here of the real part of the scalar product of derivation for the frequency parameter according to which the refinement has been carried out.

Therefore, when the modulus of Pₛ is strictly higher than the modulus of P_{θ}, the quantification module 20 quantifies the real part of the scalar product of derivation for the second expansion parameter. When the modulus of Pₛ is lower than or equal to the modulus of P_{θ}, the quantification module 20 quantifies the real part of the scalar product of derivation for the rotation parameter. In both cases, it is not necessary to quantify the other real part of the scalar product of derivation because it won't be transmitted.

Here again, during this anticipated quantification step, the fine value of the frequency parameter according to which the refinement is carried out is computed on the basis of the quantified real part of the scalar product of derivation. When the hybrid refinement has been carried out according to the rotation parameter, it is considered in the rotation parameter refinement formula that the fine value of the second expansion parameter is equal to the raw value of the second expansion parameter for computing the fine value. The fine value of the rotation parameter is the calculated according to Math. 30, as described hereinafter with reference to the construction method.

Here, the quantification module 20 implements a Lloyd Max quantifier, for example over 16 levels or 32 levels.

Thereafter, the decomposition module 10 computes, in the same way as in the first embodiment, on the basis of the second wavelet determined at the refinement step: the fine coefficient, the raw coefficient, the decision, the memorized coefficient and the memorized wavelet. This computation is carried out similarly to step and E7 of the first embodiment.

The decomposition module 10 then determines the residue r in the same way as in step E8 of the first embodiment. Also in this second embodiment, the steps presented hereinabove are iterated L times.

After having carried out L iterations, the decomposition module 10 has in particular determined the following data, which represent the digital hologram: L groups of raw values, L groups of fine values, L memorized coefficients, L decisions and L choices.

Previously to the encoding, the scheduling module 20 schedules the data representing the digital hologram stemming from each iteration according to a line-by-line scanning scheme, in the same way as in step E9 of the first embodiment.

During an encoding and transmission step (corresponding to step E10), data representing the hologram are encoded and transmitted. This step comprises the generation of a data flow containing sufficient information for constructing the digital hologram.

During this step, the encoding module 30 thus here encodes into the data flow the following variables:
i) the memorized coefficients,
ii) the positions consisted by the raw values of the spatial parameters,
iii) the raw values of the frequency parameters,
iv) the decisions, grouped under the notation,
iv) the choices, grouped under the notation.

Also in this second embodiment, the refinement values of the spatial parameters are negligible with respect to the raw values. Only the raw values of the spatial parameters are thus transmitted.

The encoding module 30 also encodes into the data flow the following variables: vi) the real parts of the scalar products of derivation for the frequency parameters.

In this second embodiment, for each iteration, the encoding module 30 encodes more particularly, among the real parts of the scalar products of derivation for the two frequency parameters, only that for the frequency parameter according to which the hybrid refinement has been carried out at said iteration (i.e. either the second expansion parameter or the rotation parameter).

The positions and the raw values of the frequency parameters are data representing raw values. The real parts of the scalar products for the frequency parameters are data representing refinement values.

In other words, the encoding module 30 encodes, for each iteration, the real part of the scalar product of derivation for the frequency parameter according to which the refinement has been carried out, i.e. either the real part of the scalar product of derivation according to the rotation parameter, or the real part of the scalar product of derivation according to the second expansion parameter.

The raw values of the frequency parameters are here encoded using a uniform scalar quantifier, for example over 8 levels.

The data flow in this second embodiment thus offers a very good compromise between the quantity of transmitted data that is for example lower than in the first embodiment, and the quality of the decomposition of the digital hologram that remains very representative of the digital hologram thanks to the refinement.

As shown in FIG. 7, in this second embodiment, the data flow F is more particularly constructed as follows.

The data flow F first comprises a main header EP that indicates the beginning of the data flow F and that is representative: of the metadata M, the type of encoding used (levels of quantification, number of contexts used by the entropic encoder) and the order of encoding of the variables, such as shown for example in FIG. 7.

The metadata M comprise in particular lists containing, for each of the variables, the values they can take. These lists comprise in particular the discrete sets of values for the frequency parameters. Here, the metadata M also comprise the resolution of the digital hologram H, from which the decoding module 60 determines the discrete sets of values for the spatial parameters. The variables are here encoded into the data flow F in the form of indices, for example from 1 to 32 for the real parts of the scalar products for the frequency parameters that have been quantified by a Lloyd Max quantifier over 32 levels.

The data flow F also comprises an end marker MF delimiting the end of the data flow F.

The data flow F then comprises wavelet markers MO. In FIG. 7, the wavelet marker denoted MO_{K} delimits the part of the data flow F encoding for the variables i) to vi) stemming from iteration K, i.e. for the decomposition wavelet determined at iteration K. The variables are thus grouped by iteration, from the first iteration, delimited by the marker, denoted MO₁, to the last one.

The data flow F then comprises variable markers MV. The variable markers MV delimit, between two wavelet markers MO (or between the last wavelet marker and the end marker MF), the parts of the data flow F encoding for each of the variables i) to vi) stemming from a same iteration of the decomposition.

Thus, in the example illustrated in FIG. 7 for iteration K, the variable markers MV delimit, between the wavelet markers MO_{K} and MO_{K+1}, the parts of the data flow F encoding successively for:
the positions, and more specifically differences Δp_{K} between two consecutive positions after “raster scan” scheduling,
the decision d_{K},
the choice h_{K},
the raw value of the second expansion parameter s_{c,K},
the raw value of the rotation parameter θ_{c,K},
the real part of the scalar product of derivation for the frequency parameter according to which the hybrid refinement has been carried out R[D_{sc|θc}]K,
the real part of the memorized coefficient c^{re}_{m,K},
the imaginary part of the memorized coefficient c^{re}_{m,K}.

Once the data flow F encoded, the transmission module 40 transmits it to the construction device 200.

In this second embodiment, given that the raw values of the spatial frequency parameters are transmitted (and not only the raw values of the spatial parameters as in the first embodiment), combining these latter with the real parts of the scalar products of derivation for the frequency parameters makes it possible to directly obtain the second wavelets from the decomposition. In other words, it is not necessary to determine the triplets of raw values as illustrated in FIG. 6.

In this second embodiment, the construction method starts with a reception step (corresponding to step E11) in which the reception module 50 receives the data flow F and transmits it to the decoding module 60. The decoding module 60 decodes, in particular thanks to the information contained in the main header EP, the data representing the digital hologram.

In this second embodiment, by symmetry with the encoding, the decoding module 60 extracts from the data flow:
i) the memorized coefficients,
ii) the positions,
iii) the raw values of the frequency parameters,
iv) the decisions, and
v) the choices,
vi) the real parts of the scalar products of derivation for the frequency parameters.

For each iteration, the decoding module 60 decodes more particularly from the data flow, among the real parts of the scalar products of derivation for the two frequency parameters, only that for the frequency parameter according to which the hybrid refinement has been carried out at said iteration (either the second expansion parameter or the rotation parameter).

The data extracted by the decoding module 60 are grouped by packets, a packet containing all the data from a same iteration of the decomposition method.

During the following step, the decoding module 60 determines the construction values of the spatial frequency parameters.

In this second embodiment, the decoding module 60 determines a group of four construction values for each iteration of the decomposition: one for each spatial parameter and one for each frequency parameter. The decoding module 60 thus determines four construction values for each wavelet marker of the data flow.

Here, the decoding module 60 thus performs L times (for the L iterations of the decomposition) the determination of four construction values and thus determines L construction wavelets, each characterized by a group of four construction values. Here, only the determination of the construction values associated with iteration K of the decomposition are described in detail.

When the decision d_{K} indicates that the wavelet memorized at iteration K of the decomposition method is the first wavelet characterized by the raw values, i.e. here when the decision d_{K} is equal to 0, the decoding module 60 determines the construction values as being equal to the considered raw values of the spatial frequency parameters. The decoding module 60 thus considers in particular the raw values of the frequency parameters stemming from iteration K of the decomposition method and characterizes the construction wavelet on the basis of these raw values.

When the decision d_{K} indicates that the wavelet memorized at iteration number K of the decomposition method is the second wavelet, which is here characterized by a fine value of a frequency parameter and by the raw values for the other parameters, the decoding module 60 determines, on the basis of the choice h_{K}, which frequency parameter has been used for the hybrid refinement at iteration K. This here corresponds to the case where the decision d_{K} is equal to 1.

In a first case, when the choice h_{K} indicates that the hybrid refinement has been carried out at iteration K according to the second expansion parameter, i.e. here when the choice h_{K} is equal to 1, the construction value for the second expansion parameter is determined, on the basis of the raw value of the second expansion parameter and the real part of the scalar product of derivation for the second expansion parameter, in accordance with the refinement formula for the scalar product of derivation, i.e. in accordance with Math. 23. In this first case, the other construction values, i.e. those of the two spatial parameters and that of the rotation parameter, are all three determined by the decoding module 60 as being equal to the raw values of these parameters stemming from iteration K of the decomposition.

In a second case, when the choice h_{K} indicates that the hybrid refinement has been carried out during iteration K according to the rotation parameter, i.e. when the choice h_{K} is equal to 0, the construction value for the rotation parameter is determined, on the basis of the raw value of the rotation parameter and the real part of the scalar product of derivation for the rotation parameter, according to the rotation parameter refinement formula, i.e. in accordance with Math. 29, in which it is considered that the fine value of the second expansion parameter is equal to the raw value of the second expansion parameter. In other words, the construction value θ_{K} for the rotation parameter is determined according to the following formula:

$${θ}_{K} = {θ}_{c} + {sin}^{- 1} ( \frac{2}{{π}^{2}} R [ {D}_{{θ}_{c}} ] ) \qquad [ Math . 30 ]$$

In this second case, the other construction values, i.e. those of the two spatial parameters and that of the second expansion parameter, are all three determined by the decoding module 60 as being equal to the raw values of these parameters stemming from iteration K of the decomposition.

Once determined, the construction wavelets are sent to the construction module 70. As in the first embodiment, the construction module 70 then computes the digital hologram by summing the contribution of the different construction wavelets weighted by their associated memorized coefficient.

In a first alternative of this second embodiment, it is possible to carry out the refinement both according to the second expansion parameter and according to the rotation parameter. In other words, it is possible not to apply the hybrid refinement but a refinement according to all the frequency parameters, as in the first embodiment. The real parts of the scalar products of derivation for these two parameters are then quantified, preferably in an anticipated manner, for example using a Lloyd Max quantifier, for example over 16 levels or 32 levels.

In this first alternative, the data flow then comprises the real parts of the scalar product of derivation for the rotation parameter and the scalar product of derivation for the second expansion parameter but does not comprise the choices.

In this first alternative, when the decision indicates that the wavelet memorized at iteration K of the decomposition method is the second wavelet, each construction value of the frequency parameters is then determined by carrying out the combination of the raw value with the real part(s) of the scalar products of derivation according to the refinement formulas, i.e. according to Math. 23 and Math. 29.

In this first alternative of this second embodiment, the constructed hologram is thus more representative of the digital hologram but the quantity of data to be transmitted, i.e. the size of the data flow, is higher.

In a second alternative of this second embodiment, at the refinement step, the decomposition module implements the following formulas for α and γ for determining the fine value of the second expansion parameter:

α=−1+s_{c}R[Dₛ_{_{c}}]−s_{c}²(R[Dₓ_{_{c}}]²+R[D_{y}_{_{c}}]²) [Math. 31]

and

γ=R[D_{θ}_{_{c}}]²−I[D_{θ}_{_{c}}]²−R[D′_{θ}_{_{c}}] [Math. 32]

where D′_{θc} represents the scalar product of derivation of the second order between the digital hologram and a second derivative of the first wavelet with respect to the second expansion parameter. The formula of D′_{θc} is thus the following:

$${D}_{{θ}_{c}}^{′} = \frac{〈 H , \frac{{\partial }^{2}}{{\partial }^{2} {θ}_{c}} {g}_{{γ}_{c}} 〉}{〈 H , {g}_{{γ}_{c}} 〉} \qquad [ Math . 33 ]$$

In this second alternative, the fine value of the second expansion parameter is determined with a greater accuracy. Therefore, the fine value of the rotation parameter is also determined with a greater accuracy. This means that the second determined wavelet is more representative of the digital hologram than that determined in the general case of the second embodiment (i.e. by implementing formulas Math. 24 and Math. 29).

It is therefore advisable in particular to quantify, encode and transmit in the data flow data representing the following refinement values: the real part of the scalar product of derivation for each spatial frequency parameter and the real part of the scalar product of derivation of the second order.

These two alternatives of the second embodiment can be implemented independently of each other or simultaneously. It can also be noted that, in the first embodiment, a hybrid refinement according to only one or two of the three frequency parameters can be implemented.

1. A method for transmitting data representing a digital hologram comprising:
determining raw values of a group of parameters, each said raw value being determined from a discrete set of predetermined values, said raw values being determined in such a way that a first scalar product between said digital hologram and a first decomposition wavelet characterized by said raw values is maximum;
computing, for each parameter of said group of parameters, a refinement value as a function of a scalar product of derivation determined on the basis of a scalar product between said digital hologram and a derivative of said first decomposition wavelet relative to said parameter;
determining a coefficient on the basis of a second scalar product between said hologram and a second decomposition wavelet characterized by fine values obtained by a combination of said raw values and said refinement values; and
transmitting:
i) data representing said refinement values;
ii) said coefficient.

2. The transmission method according to claim 1, wherein the transmitting step further comprises transmitting iii) data representing said raw values.

3. The transmission method according to claim 1, wherein said group of parameters includes at least one frequency parameter, and
wherein said method further comprises:
transmitting, for each of said at least one frequency parameter, metadata representing said discrete set of predetermined values.

4. The transmission method according to claim 1, wherein said group of parameters includes at least one frequency parameter, and wherein said data representing said refinement values comprise, for each of said at least one frequency parameter, a real part of said scalar product of derivation.

5. The transmission method according to claim 1, wherein said group of parameters includes at least one spatial parameter, said method comprising a step of transmitting data representing the raw value of each of said at least one spatial parameter.

6. The transmission method according to claim 1, further comprising:
quantifying said refinement values, and
obtaining said fine values on the basis of said quantified refinement values.

7. The transmission method according to claim 1, further comprising:
transmitting a decision relating to a comparison between a modulus of said first scalar product and a modulus of said second scalar product.

8. The transmission method according to claim 1, further comprising:
encoding said data representing said refinement values and said coefficient into a data flow.

9. A device for transmitting a digital hologram comprising:
a decomposition module programmed to perform a method comprising:
a) determining raw values of a group of parameters, each said raw value being determined from a discrete set of predetermined values, said raw values being determined in such a way that a first scalar product between said hologram and a first decomposition wavelet characterized by said raw values is maximum;
b) for each parameter of said group, computing a refinement value as a function of a scalar product of derivation determined on the basis of a scalar product between said hologram and a derivative of said first decomposition wavelet relative to said parameter;
c) determining a coefficient on the basis of a second scalar product between said hologram and a second decomposition wavelet characterized by fine values obtained by a combination of said raw values and said refinement values; and
a transmission module configured to transmit:
i) data representing said refinement values;
ii) said coefficient.

10. A method for constructing a digital hologram comprising:
receiving:
i) data representing refinement values of a group of parameters, and
ii) a coefficient associated with a decomposition wavelet;
determining construction values on the basis of said data representing said refinement values each said construction value being associated with a parameter of said group;
determining said decomposition wavelet characterized by said construction values; and
constructing said hologram by weighting said decomposition wavelet by said coefficient.

11. The method according to claim 10, further comprising:
receiving a decision:
wherein the determining of the decomposition wavelet is also performed on the basis of said decision.

12. The method according to claim 10, further comprising:
decoding a data flow and extracting said data representing refinement values and said coefficient.

13. The method according to claim 10, further comprising:
for at least one parameter from the group of parameters, determining, on the basis of said data representing said refinement values, a raw value relating to the at least one parameter from a discrete set of values.

14. The method according to claim 13, further comprising:
receiving metadata, and
determining said discrete set of values on the basis of the metadata.

15. The method according to claim 10, wherein the receiving further comprises receiving:
iii) data representing at least one raw value relating to at least one of the parameters from the group of parameters.

16. The method according to claim 13, further comprising:
at least for said parameter, determining said construction value on the basis of said data representing said refinement values and said raw value relating to said parameter.

17. A device for constructing a digital hologram comprising:
a reception module configured to receive:
i) data representing refinement values of a group of parameters,
ii) a coefficient associated with a decomposition wavelet;
a decoding module programmed to perform a method comprising:
a) determining construction values on the basis of said data representing said refinement values, each said construction value being associated with a parameter of said group;
b) determining said decomposition wavelet characterized by said construction values;
a construction module programmed to perform a method comprising:
c) constructing said hologram by weighting said decomposition wavelet by said coefficient.

18. A system for transmitting and constructing a digital hologram comprising:
a transmission device according to claim 10; and
a device for constructing a digital hologram comprising:
a reception module configured to receive:
i) data representing refinement values of a group of parameters,
ii) a coefficient associated with a decomposition wavelet;
a decoding module programmed to perform a method comprising:
a) determining construction values on the basis of said data representing said refinement values, each construction value being associated with a parameter of said group;
b) determining said decomposition wavelet characterized by said construction values;
a construction module programmed to perform a method comprising:
c) constructing said hologram by weighting said decomposition wavelet by said coefficient.

19. The system according to claim 18, wherein the transmission device further comprises an encoding module programmed to encode said data representing said refinement values and said coefficient into a data flow.

20. The system according to claim 19, wherein said reception module receives the data flow comprising said data representing refinement values and said coefficient, and wherein said decoding module is programmed to decode said data flow and extract said data representative of refinement values and said coefficient.

21. A data flow including:
a first set of data representing fine values obtained by a combination of raw values, characterizing a first decomposition wavelet, and refinement values computed as a function of scalar products of derivation determined on the basis of scalar products between a digital hologram and a derivative of said first decomposition wavelet; and
a second set of data representing a coefficient determined on the basis of a scalar product between said hologram and a second decomposition wavelet characterized by said fine values.

22. The data flow according to claim 21, further including a third set of data representing said raw values, said raw values being determined in such a way that a scalar product between the hologram and said first decomposition wavelet is maximum.

23. The data flow according to claim 22, further including a fourth set of data representing discrete sets of predetermined values, each said raw value being determined as one of said predetermined values.
